(19) United States
(12) Patent Application Publication
(10) Pub. No.: US 2026/0266344 A1
(43) Pub. Date: Sep. 10, 2026

(54) PAD LINER AND BRAKE ASSEMBLY INCLUDING THE SAME

(71) Applicant: HL Mando Corporation, Pyeongtaek (KR)

(72) Inventor: Raeung JEONG, Pyeongtaek (KR)

(21) Appl. No.: 19/532,216

(22) Filed: Feb. 6, 2026

(30) Foreign Application Priority Data
Mar. 6, 2025 (KR) 10-2025-0028746

(51) Int. Cl. F16D 65/097; F16D 55/00

(52) U.S. Cl. CPC F16D 65/0979; F16D 65/0977; F16D 2055/0041

(57) ABSTRACT

A brake pad liner and a brake assembly including the same are disclosed. The brake assembly may include: at least one brake pad configured to generate a braking force by contacting a disc, a front side of the brake pad facing the disc; a bracket on which the brake pad is slidably installed; a caliper slidably mounted on the bracket to operate the brake pad; and one or more brake pad liners disposed between the bracket and the brake pad to slidably support the brake pad, wherein the brake pad liner includes: a body disposed such that a front side thereof faces a side portion of the brake pad; and a spring configured to extend from the body, advance toward a front side from a rear side of the brake pad to contact the brake pad, and press the brake pad rearward.

### CROSS-REFERENCE TO RELATED APPLICATION

This application claims priority to and benefit from Korean Patent Application No. 10-2025-0028746, filed on Mar. 6, 2025, the disclosure of which is incorporated herein by reference in its entirety.

### 2. BACKGROUND

### 1. Technical Field

The present disclosure relates to a brake pad liner and a brake assembly including the same, and more particularly, to a brake pad liner configured to guide movement of a brake pad that generates braking force by contacting a disc installed on a wheel of a vehicle, and a brake assembly including the same.

### 2. Related Art

A brake assembly constitutes a brake that is mounted on a vehicle and operates to reduce the speed of the vehicle or maintain the vehicle in a stopped state. A brake assembly forming a caliper brake includes brake pads that generate braking force by pressing both sides of a disc rotating together with a wheel of the vehicle, a bracket on which the brake pads are installed, a caliper that operates the brake pads, and brake pad liners that are disposed between the bracket and the brake pads.

The brake pad liner includes a return spring that presses the brake pad toward a non-braking position. The return spring needs to provide sufficient force to the brake pad while ensuring high durability.

### SUMMARY

An object of the present disclosure is to provide a brake pad liner and a brake assembly including the same that apply an enhanced returning force to a brake pad so that the brake pad can reliably return to a non-braking position when braking is released.

Another object of the present disclosure is to provide a brake pad liner and a brake assembly including the same having improved durability of a spring that applies a returning force.

The objects of the present disclosure are not limited to the above-described objects, and other objects that are not mentioned will be able to be clearly understood by those skilled in the art to which the present disclosure pertains from the following description.

According to an aspect of the present disclosure, a brake assembly is provided, comprising: at least one brake pad configured to generate a braking force by contacting a disc, a front side of the brake pad facing the disc; a bracket on which the brake pad is slidably installed; a caliper slidably mounted on the bracket to operate the brake pad; and one or more brake pad liners disposed between the bracket and the brake pad to slidably support the brake pad, wherein the brake pad liner includes: a body disposed such that a front side thereof faces a side portion of the brake pad; and a spring configured to extend from the body, advance toward a front side from a rear side of the brake pad to contact the brake pad, and press the brake pad rearward.

In a brake assembly according to one aspect of the present disclosure, the spring may include a first extending arm configured to extend forward from the body.

In a brake assembly according to one aspect of the present disclosure, the body may include a base, a lower leg configured to protrude forward from a lower end of the base, and an upper leg configured to protrude forward from an upper end of the base, and the first extending arm is connected to one side of the upper leg.

In a brake assembly according to one aspect of the present disclosure, the first extending arm may be connected to an upper portion of one side of the upper leg.

In a brake assembly according to one aspect of the present disclosure, the first extending arm may include a portion obliquely extending outward away from the disc.

In a brake assembly according to one aspect of the present disclosure, the spring may further include a second extending arm that is bent from the first extending arm and extends rearward toward the body.

In a brake assembly according to one aspect of the present disclosure, the spring may further include a third extending arm that is bent from the second extending arm and extends forward away from the body.

In a brake assembly according to one aspect of the present disclosure, the third extending arm may include a portion obliquely extending inward toward the disc.

In a brake assembly according to one aspect of the present disclosure, the spring may further include a tip that is bent from a front end of the third extending arm and extends outward away from the disc.

In a brake assembly according to one aspect of the present disclosure, the spring may further include a rear extending arm that extends rearward from the body and is turned in direction to extend forward.

In a brake assembly according to one aspect of the present disclosure, the spring may have at least one slit penetrating the spring along its extension direction.

In a brake assembly according to one aspect of the present disclosure, the bracket may include a locking ledge protruding upward from a portion that contacts a rear side of the brake pad liner, and the brake pad liner may further include a grip connected to an upper side of the body to be caught by the locking ledge for fixation.

According to another aspect of the present disclosure, a brake pad liner is provided, comprising: a body including a base, a lower leg configured to protrude forward from a lower end of the base, and an upper leg configured to protrude forward from an upper end of the base; and a spring including a first extending arm configured to extend forward from one side of the upper leg and a second extending arm that is bent from the first extending arm and extends rearward toward the body.

In a brake pad liner according to one aspect of the present disclosure, the first extending arm may be connected to an upper portion of one side of the upper leg.

In a brake pad liner according to one aspect of the present disclosure, the first extending arm may include a portion obliquely extending to one side.

In a brake pad liner according to one aspect of the present disclosure, the spring may further include a third extending arm that is bent from the second extending arm and extends forward away from the body.

In a brake pad liner according to one aspect of the present disclosure, the first extending arm may include a portion obliquely extending to one side, and the third extending arm includes a portion obliquely extending to the other side.

In a brake pad liner according to one aspect of the present disclosure, the spring may further include a tip that is bent from a front end of the third extending arm and extends to one side.

In a brake pad liner according to one aspect of the present disclosure, the spring may have at least one slit penetrating the spring along its extension direction.

In a brake pad liner according to one aspect of the present disclosure, the brake pad liner may further comprise a grip configured to extend upward from a front end of the upper leg to extend rearward.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of a brake assembly according to an embodiment of the present disclosure.

FIG. 2 is a view illustrating a separated state of a caliper of the brake assembly according to an embodiment of the present disclosure.

FIG. 3 is a perspective view of a bracket of the brake assembly according to an embodiment of the present disclosure.

FIG. 4 is a front perspective view of a brake pad liner according to an embodiment of the present disclosure.

FIG. 5 is a front perspective view of the brake pad liner according to an embodiment of the present disclosure, viewed from a different angle from FIG. 4.

FIG. 6 is a rear perspective view of a brake pad liner according to an embodiment of the present disclosure.

FIG. 7 is a plan view of a brake pad liner according to an embodiment of the present disclosure.

FIG. 8 is a side view of a brake pad liner according to an embodiment of the present disclosure.

FIG. 9 is a perspective view of a state in which a brake pad liner according to an embodiment of the present disclosure is coupled to a bracket and a brake pad is disposed.

FIG. 10 is a view illustrating a state, in which the brake pad liner according to an embodiment of the present disclosure is coupled to the bracket and the brake pad is disposed, in a side view of the brake pad liner.

FIG. 11 is a plan view of a state in which the brake pad liner according to an embodiment of the present disclosure is coupled to the bracket and the brake pad is disposed.

FIG. 12 is a view illustrating an operation of a spring of a brake pad liner in the brake assembly according to an embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

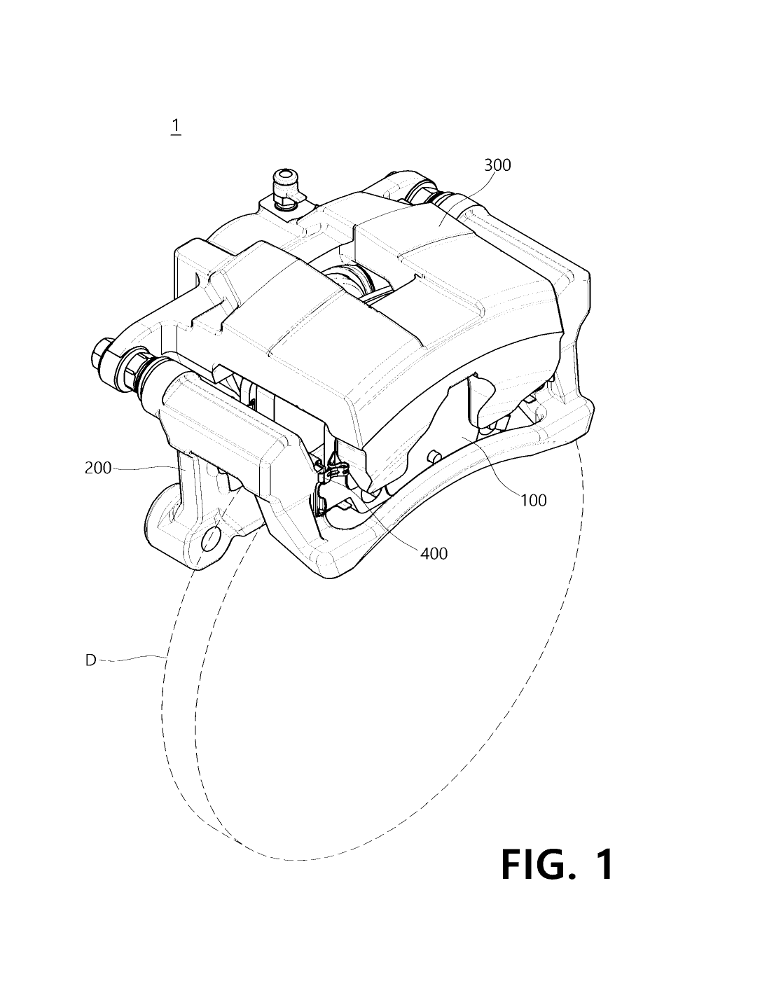

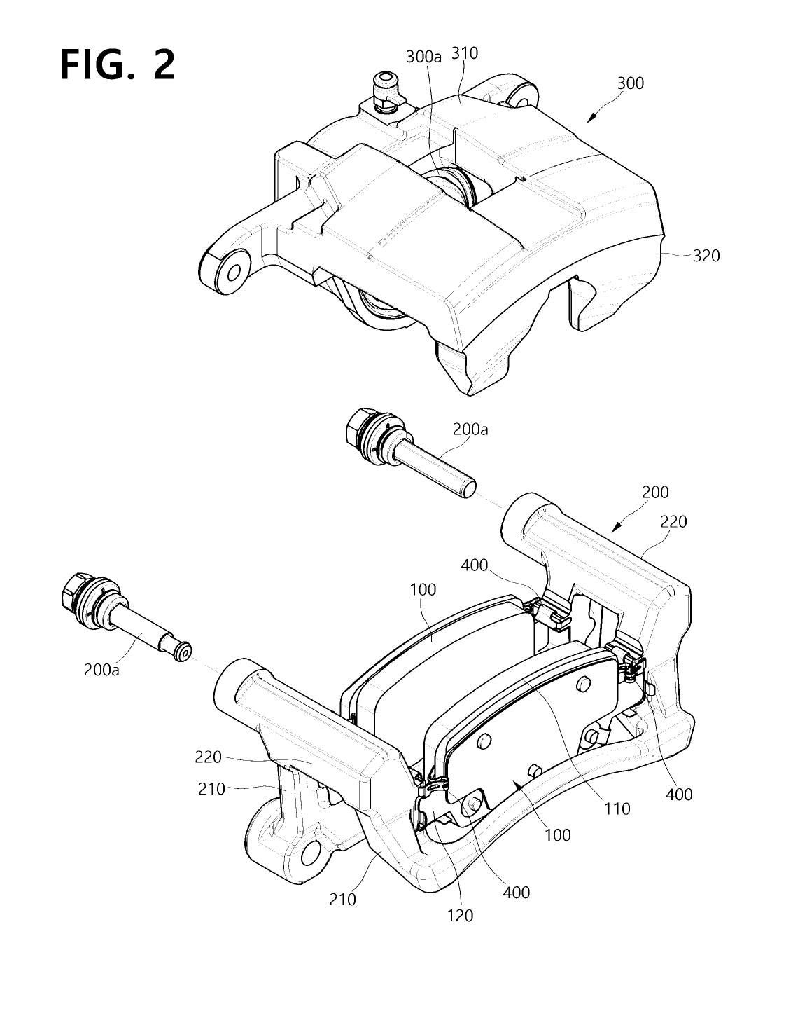

FIG. 1 is a perspective view of a brake assembly according to an embodiment of the present disclosure. FIG. 2 is a view illustrating a separated state of a caliper of the brake assembly according to an embodiment of the present disclosure.

The brake assembly 1 according to an embodiment of the present disclosure is installed in a vehicle and generates a braking force by coming into contact with a disc D that rotates together with a wheel of the vehicle. The brake assembly 1 may provide the braking force for decelerating or stopping the vehicle during driving of the vehicle. In addition, the brake assembly 1 may restrict rotation of the disc D in a stopped or parked state of the vehicle so that the stopped or parked state of the vehicle is maintained.

Referring to FIGS. 1 and 2, a brake assembly 1 according to an embodiment of the present disclosure includes a brake pad 100, a bracket 200, a caliper 300, and a brake pad liner 400.

The brake pad 100 is disposed to be contactable with one surface of the disc D. The brake pad 100 may be arranged such that a front side thereof faces one surface of the disc D to generate the braking force by contacting the disc D.

At least one brake pad 100 may be disposed. In an embodiment of the present disclosure, the brake assembly 1 includes a pair of brake pads 100 respectively disposed to be contactable with both side surfaces of the disc D.

When defining a surface of the disc D shown in FIG. 1 that is illustrated to be visible as an outer surface of the disc D, and the opposite surface thereof as an inner surface of the disc D, one of the pair of brake pads 100 is disposed to be contactable with the outer surface of the disc D, and the other one is disposed to be contactable with the inner surface of the disc D. In other words, the pair of brake pads 100 may be disposed to face each other spaced apart so as to be respectively contactable with the outer surface and the inner surface of the disc D.

Referring to FIG. 2, the brake pad 100 includes a brake pad body 110 having a friction material disposed thereon to generate a braking force through friction by contacting the disc D, and protrusions 120 respectively protruding laterally from both sides of the brake pad body 110.

The bracket 200 supports the brake pad 100. The brake pad 100 is slidably installed on the bracket 200. The bracket 200 may be configured such that the pair of brake pads 100 are movable forward toward or backward away from the outer surface or the inner surface of the disc D.

The bracket 200 may be installed on a knuckle (not shown) of the vehicle. The bracket 200 may be disposed to surround one side of an outer circumference of the disc D. More specifically, a portion of the disc D may enter an inner side of the bracket 200 and be disposed in a rotatable state.

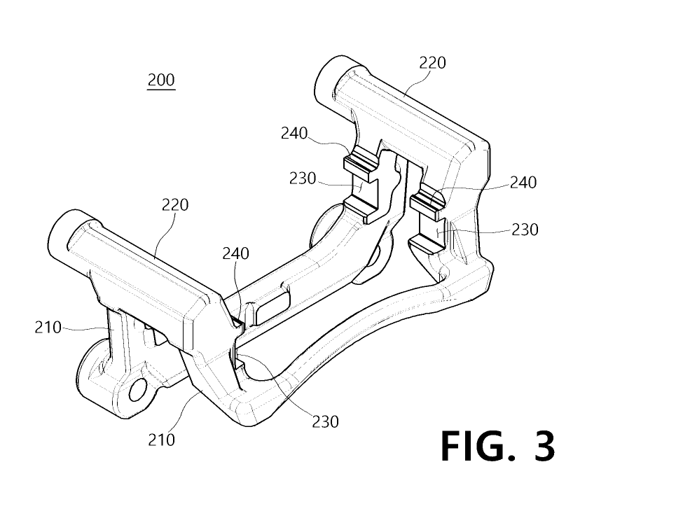

FIG. 3 is a perspective view of a bracket of the brake assembly according to an embodiment of the present disclosure.

Referring to FIG. 3, the bracket 200 includes a bracket body 210 in which the pair of brake pads 100 are installed to be movable toward and away from the disc D. In an embodiment of the present disclosure, the bracket body 210 may include a pair of bracket bodies 210 spaced apart from each other and facing each other so that the pair of brake pads 100 are respectively disposed therebetween. The pair of bracket bodies 210 are spaced apart from each other, and the disc D may enter a space therebetween and be disposed therein.

The bracket body 210 is configured to support a lower portion and both sides of the brake pad 100. For example, the bracket body 210 may have a generally U-shaped form.

The pair of bracket bodies 210 may be connected to each other by a bracket bridge 220. More specifically, the bracket bridge 220 connects upper ends on both sides of the pair of bracket bodies 210 so that the pair are arranged side by side. The pair of bracket bodies 210 and the pair of bracket bridges 220 may be integrally formed.

The bracket 200 may further include bracket grooves 230 into which protrusions 120 disposed on both sides of each brake pad 100 are fitted, and locking ledges 240 disposed above the bracket grooves 230. More specifically, inner side surfaces on both lateral sides of each bracket body 210 are recessed inward to form the bracket grooves 230, and each locking ledges 240 may be formed to protrude upward from an upper portion of the bracket groove 230 of each bracket body 210.

The grooves 230 and the locking ledges 240 are respectively provided on both sides of each bracket body 210. In other words, the bracket 200 may have four grooves 230 and four locking ledges 240.

The caliper 300 is slidably mounted on the bracket 200. The caliper 300 operates the brake pad 100. More specifically, the caliper 300 operates the brake pad 100 while sliding relative to the bracket 200.

Referring to FIG. 2, the caliper 300 may be mounted on the bracket 200 by a pair of sliding pins 200a that penetrate the caliper 300 from both sides thereof and are inserted into the bracket 200.

The pair of sliding pins 200a may be respectively coupled one-to-one to the pair of bracket bridges 220. In this case, each sliding pin 200a may be disposed such that an axial direction thereof is parallel to a moving direction of the brake pad 100. The caliper 300 may move forward or backward relative to the bracket 200 along the sliding pins 200a.

The caliper 300 includes a caliper body 310 and a caliper finger 320.

An actuator 300a is disposed in the caliper body 310. The actuator 300a may be operated hydraulically or mechanically. If the brake pad 100, which is disposed to face an inner surface of the disc D, is pressed toward the disc D by the actuator 300a to come into contact with the inner surface of the disc D, the caliper body 310 presses the inner surface of the disc D and slides along the sliding pins 200a.

The caliper finger 320 is connected to the caliper body 310 so as to contact the brake pad 100 that is disposed to face an outer surface of the disc D. When the caliper body 310 presses the inner surface of the disc D and slides along the sliding pins 200a, the caliper finger 320 moves the brake pad 100, which is disposed to face the outer surface of the disc D, toward the outer surface of the disc D.

The brake pad liner 400 is disposed between the bracket 200 and the brake pad 100 to slidably support the brake pad 100. Referring to FIGS. 2 and 3, the brake pad liner 400 may be coupled to the bracket groove 230 and the locking ledge 240 formed on the bracket body 210.

The brake pad liner 400 may be provided in one or more. In an embodiment of the present disclosure, four brake pad liners 400 are provided. More specifically, the brake pad liners 400 may be respectively disposed to correspond one-to-one to each protrusion 120 of the pair of brake pads 100.

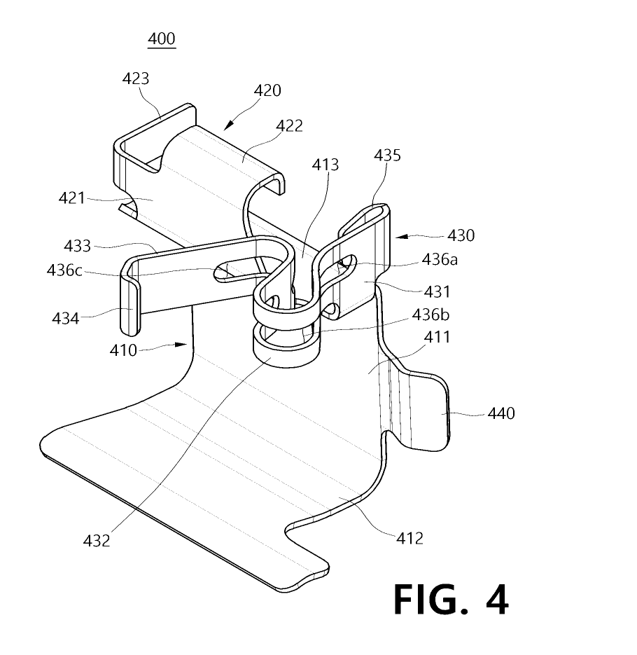

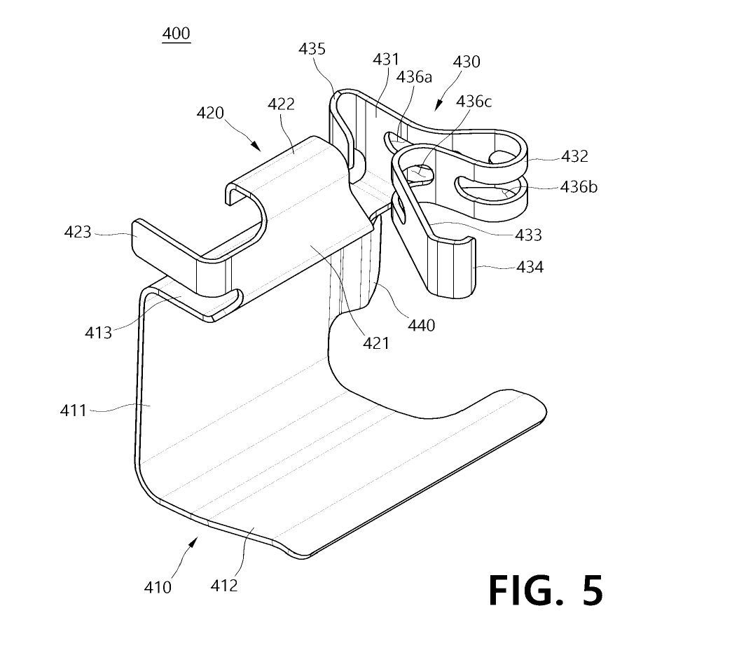

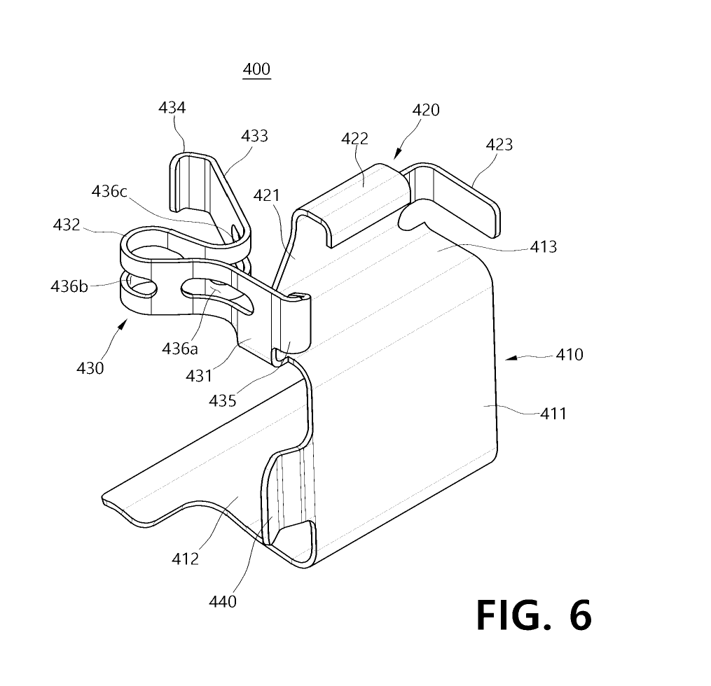

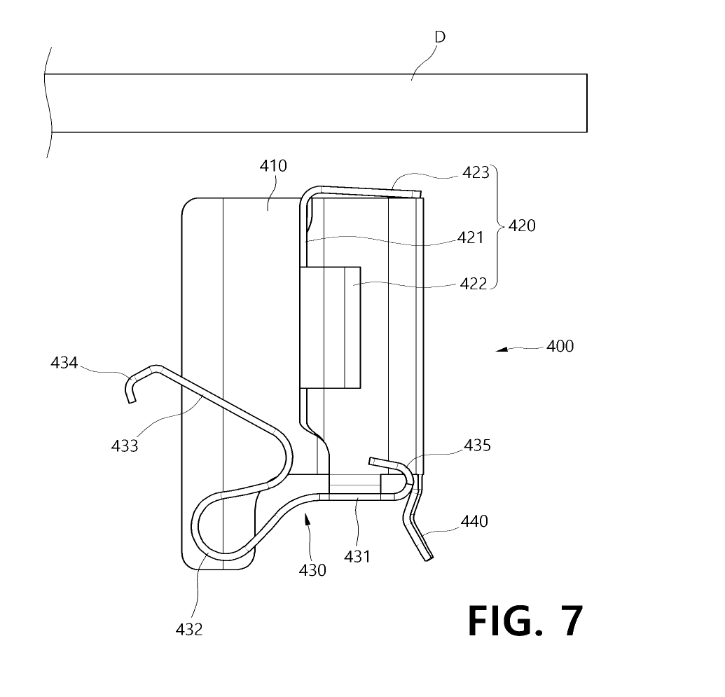

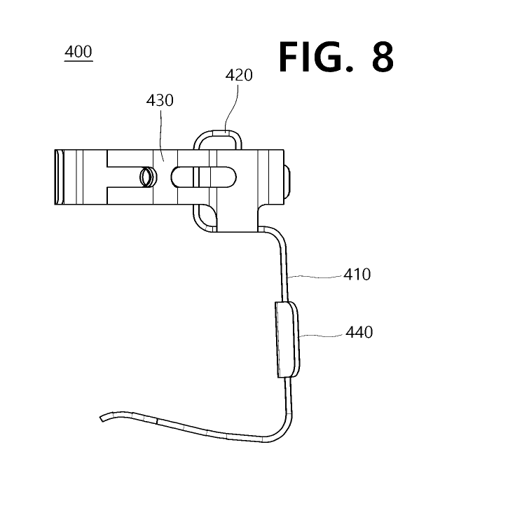

FIG. 4 is a front perspective view of a brake pad liner according to an embodiment of the present disclosure. FIG. 5 is a front perspective view of the brake pad liner according to an embodiment of the present disclosure, viewed from a different angle from FIG. 4. FIG. 6 is a rear perspective view of a brake pad liner according to an embodiment of the present disclosure. FIG. 7 is a plan view of a brake pad liner according to an embodiment of the present disclosure. FIG. 8 is a side view of a brake pad liner according to an embodiment of the present disclosure.

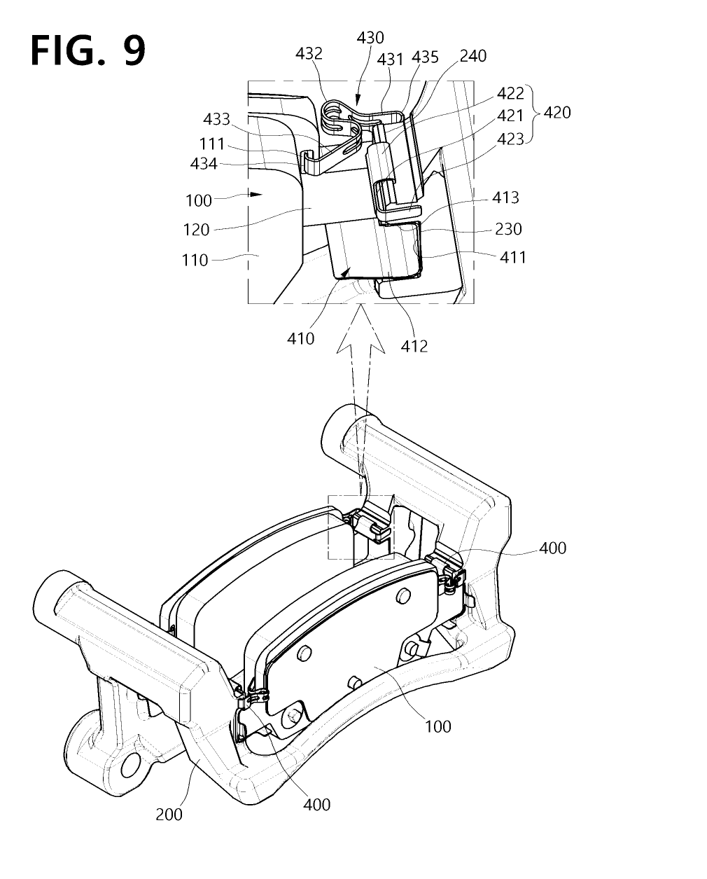

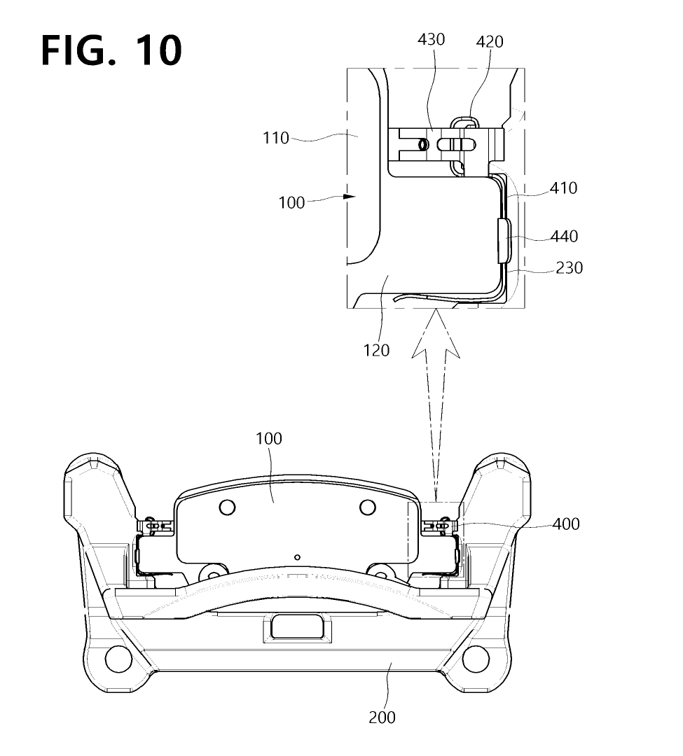

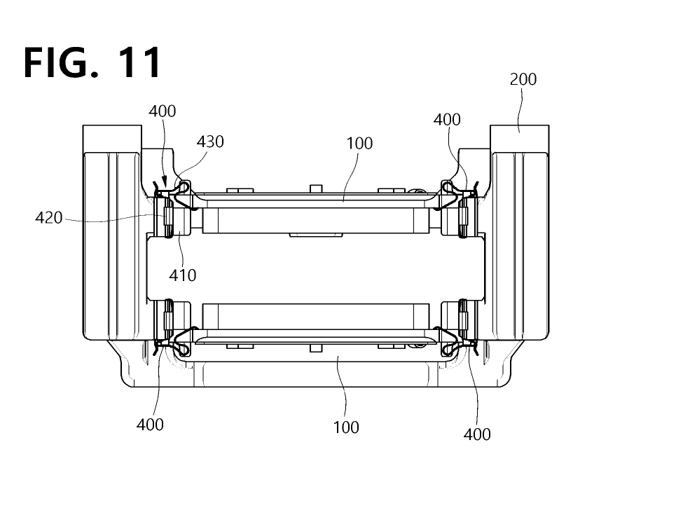

FIG. 9 is a perspective view of a state in which a brake pad liner according to an embodiment of the present disclosure is coupled to a bracket and a brake pad is disposed. FIG. 10 is a view illustrating a state, in which the brake pad liner according to an embodiment of the present disclosure is coupled to the bracket and the brake pad is disposed, in a side view of the brake pad liner. FIG. 11 is a plan view of a state in which the brake pad liner according to an embodiment of the present disclosure is coupled to the bracket and the brake pad is disposed.

Referring to FIGS. 4 to 11, the brake pad liner 400 may include a body 410, a grip 420, and a spring 430.

The body 410 is disposed such that a front side thereof faces a side portion of the brake pad 100. A rear portion of the body 410 may be disposed in contact with the bracket 200.

The body 410 may have a shape such that the side portion of the brake pad 100, that is, a protrusion 120 of the brake pad 100, can be inserted therein. Through this structure, the body 410 can slidably support one side of the brake pad 100.

The body 410 may include a base 411, a lower leg 412 protruding forward from a lower end of the base 411, and an upper leg 413 protruding forward from an upper end of the base 411. The base 411 may have a plate shape. The base 411 may be disposed upright relative to an installation surface. In addition, the lower leg 412 and the upper leg 413 may be formed by bending upper and lower portions of the base 411 forward, respectively.

The base 411, the lower leg 412, and the upper leg 413 form a channel having a shape corresponding to the groove 230 of the bracket 200. The base 411, the lower leg 412, and the upper leg 413 are inserted into and disposed in the groove 230.

The protrusion 120 of the brake pad 100 may be inserted into the channel formed by the base 411, the lower leg 412, and the upper leg 413. The brake pad 100 may slide toward the disc D or away from the disc D within the channel formed by the base 411, the lower leg 412, and the upper leg 413.

The grip 420 is connected to an upper side of the body 410. The grip 420 may be caught by and fixed to the locking ledge 240 of the bracket 200. The locking ledge 240 of the bracket 200 may protrude upward from a portion of the bracket body 210 that contacts a rear side of the brake pad liner 400. In this regard, the grip 420 may be formed at a rear side of the body 410.

The grip 420 may include a grip base 421 extending upward from a front end of the upper leg 413, and a grip finger 422 extending rearward from the upper end of the grip base 421 with respect to the body 410 and further extending downward to surround an upper end and a rear side of the locking ledge 240.

Referring to FIG. 9, the locking ledge 240 of the bracket 200 may be disposed in a space formed by the upper leg 413 of the body 410, the grip base 421, and the grip finger 422 of the grip 420. In this case, the grip finger 422 may be disposed so as to at least partially surround upper and rear surfaces of the locking ledge 240.

The grip 420 may further include a grip leg 423 extending rearward from either end of the grip base 421. The grip leg 423 may be disposed in contact with the bracket body 210. The grip leg 423 allows the brake pad liner 400 to be disposed so as to surround a front surface or a rear surface of the bracket body 210, thereby stably fixing the brake pad liner 400 to the bracket 200.

The spring 430 extends from the body 410, advances toward a front side from a rear side of the brake pad 100, and contacts the brake pad 100. The spring 430 presses the brake pad 100 rearward. That is, the spring 430 presses the brake pad 100 in a direction away from the disc D.

As described above, since the brake pad 100 is disposed such that a front side thereof faces one surface of the disc D, the brake pad 100 slides forward to contact the disc D and perform braking. Meanwhile, if braking is released, the brake pad 100 needs to move rearward to be in a non-contact with the disc D. The spring 430 presses the brake pad 100 rearward, thereby moving the brake pad 100 in a direction away from the disc D if braking is released.

The spring 430 may include a first extending arm 431, a second extending arm 432, a third extending arm 433, a tip 434, and a rear extending arm 435.

The first extending arm 431 extends forward from the body 410. The first extending arm 431 may be connected to one side of the upper leg 413. That is, the first extending arm 431 may extend forward from one side of the upper leg 413. More specifically, the first extending arm 431 may be connected to an upper portion of one side of the upper leg 413.

Referring to FIG. 7, a side relatively closer to the disc D may be defined as an inner side, and a side relatively farther from the disc D may be defined as an outer side with reference to the disc D. Hereinafter, the terms “outer” and “inner” will be used based on this definition.

The first extending arm 431 may extend forward from an outer side surface of the brake pad liner 400 among both side surfaces of the brake pad liner 400. In this regard, the grip leg 423 described above may be disposed on an inner side surface of the brake pad liner 400 among both side surfaces thereof.

The first extending arm 431 may include a portion obliquely extending to one side. More specifically, the first extending arm 431 may include a portion obliquely extending outward away from the disc D.

The second extending arm 432 is bent from the first extending arm 431 and extends rearward toward the body 410. More specifically, the second extending arm 432 may be bent from an extended end of the first extending arm 431 and may extend rearward toward the grip base 421 of the grip 420, which is located above the body 410.

The second extending arm 432 may be bent in a U-shape so that its direction is turned. The second extending arm 432 may be bent from an extended end of the first extending arm 431 along an arcuate path convexly curved outward in a forward direction and may further extend rearward inward after the turn.

The third extending arm 433 is bent from the second extending arm 432 and extends forward away from the body 410. More specifically, the third extending arm 433 may be bent from an extended end of the second extending arm 432 and may extend forward away from the grip base 421 of the grip 420, which is located above the body 410.

If the first extending arm 431 includes a portion obliquely extending to one side, the third extending arm 433 may include a portion obliquely extending to the other side. That is, if the first extending arm 431 includes a portion obliquely extending outward away from the disc D, the third extending arm 433 may include a portion obliquely extending inward toward the disc D.

The tip 434 is bent from a front end of the third extending arm 433 and extends to one side. More specifically, the tip 434 may be bent from the front end of the third extending arm 433 and may extend outward away from the disc D.

The tip 434 contacts a front surface of the brake pad 100. By the tip 434 contacting the front surface of the brake pad 100, the pressing force of the spring 430 can be transmitted to the brake pad 100. In this regard, referring to FIG. 9, the brake pad 100 may include a seating groove 111 recessed in its front surface so that the tip 434 is seated therein.

The rear extending arm 435 extends rearward from the body 410 and is turned in direction to extend forward. The rear extending arm 435 extends rearward from the first extending arm 431 to a rear side of the body 410 and is turned in direction toward a front side of the body 410. The rear extending arm 435 may be bent in a U-shape after extending rearward so that its direction is turned forward inward. An extended end of the rear extending arm 435 may contact the bracket body 210.

The extended end of the rear extending arm 435 allows the brake pad liner 400 to be stably fixed to the bracket 200 by contacting a front surface or a rear surface of the bracket body 210. The rear extending arm 435 may assist in stably fixing the brake pad liner 400 to the bracket 200 together with the grip leg 423.

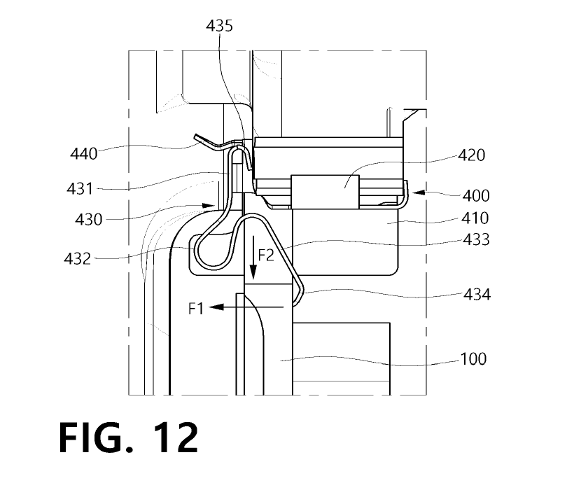

FIG. 12 is a view illustrating an operation of a spring of a brake pad liner in the brake assembly according to an embodiment of the present disclosure.

Referring to FIG. 12, the first extending arm 431, the second extending arm 432, the third extending arm 433, and the tip 434 increase an effective length of the spring 430 by being turned in direction and extended, thereby allowing the spring 430 to be subjected to lower stress for the same displacement. Accordingly, an elastic force of the spring 430 can be increased, and an enhanced returning force F1 can be provided to the brake pad 100.

At this time, the rear extending arm 435 allows the spring 430 to be supported by the bracket 200 if an extended end of the rear extending arm 435 comes into contact with a front surface or a rear surface of the bracket body 210 while the tip 434 contacts and presses the brake pad 100. Accordingly, the spring 430 can stably press the brake pad 100, suppressing plastic deformation of the spring 430 and improving durability of the brake pad liner 400.

Meanwhile, in an embodiment of the present disclosure, the spring 430 extends forward from a rear side of the brake pad 100 and contacts the brake pad 100. Accordingly, the spring 430 may additionally provide a pressing force F2 to a side of the brake pad 100.

A certain gap exists between the brake pad liner 400 and the brake pad 100. If braking is performed, as the brake pad 100 contacts the rotating disc D, the brake pad 100 receives a force in a rotational direction of the disc D and may collide with the brake pad liner 400, which can cause noise due to impacts between components. However, according to the present disclosure, since the spring 430 provides the pressing force F2 to the side of the brake pad 100 to prevent such impacts, noise caused by impacts between components can be suppressed.

Meanwhile, as best shown in FIGS. 4 to 6, the spring 430 may include at least one slit 436a, 436b, and 436c penetrating at least a part of the spring 430 along an extension direction thereof. The one or more slits 436a,436b, and 436c may be formed to penetrate both an outer surface and an inner surface of the spring 430.

In an embodiment of the present disclosure, the spring 430 may include a first slit 436a formed in the first extending arm 431, a second slit 436b formed in the second extending arm 432, and a third slit 436c formed in the third extending arm 433.

One or more slits 436a, 436b, and 436c reduce the weight of the spring 430, thereby contributing to weight reduction of the brake pad liner 400.

The brake pad liner 400 may be integrally formed with the body 410, the grip 420, and the spring 430. More specifically, the brake pad liner 400 may be formed of a single plate-shaped member, and the body 410, the grip 420, and the spring 430 may be formed by bending.

In this regard, the first extending arm 431, the second extending arm 432, the third extending arm 433, the tip 434, and the rear extending arm 435 of the spring 430 may be disposed at the same height with respect to an installation surface of the brake pad liner 400. In other words, extensions and direction changes of the first extending arm 431, the second extending arm 432, the third extending arm 433, the tip 434, and the rear extending arm 435 may be made on the same plane.

As such, when extensions and direction changes of the first extending arm 431, the second extending arm 432, the third extending arm 433, the tip 434, and the rear extending arm 435 are made on the same plane, a bending process can be efficiently performed when forming the brake pad liner 400 from a plate-shaped member.

According to the above configuration, the brake pad liner and the brake assembly including the same according to the present disclosure can provide an enhanced returning force to the brake pad through a spring having an effectively increased deployment length by being turned in direction and extended.

In addition, the brake pad liner and the brake assembly including the same according to the present disclosure provide improved durability by suppressing plastic deformation of the spring through a stable supporting structure of the spring.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A brake assembly comprising:
at least one brake pad configured to generate a braking force by contacting a disc, a front side of the brake pad facing the disc;
a bracket on which the brake pad is slidably installed;
a caliper slidably mounted on the bracket to operate the brake pad; and
one or more brake pad liners disposed between the bracket and the brake pad to slidably support the brake pad,
wherein the brake pad liner includes:
a body disposed such that a front side thereof faces a side portion of the brake pad; and
a spring configured to extend from the body, advance toward a front side from a rear side of the brake pad to contact the brake pad, and press the brake pad rearward.

2. The brake assembly of claim 1, wherein the spring includes a first extending arm configured to extend forward from the body.

3. The brake assembly of claim 2, wherein the body includes:
a base,
a lower leg configured to protrude forward from a lower end of the base, and
an upper leg configured to protrude forward from an upper end of the base, and
the first extending arm is connected to one side of the upper leg.

4. The brake assembly of claim 3, wherein the first extending arm is connected to an upper portion of one side of the upper leg.

5. The brake assembly of claim 2, wherein the first extending arm includes a portion obliquely extending outward away from the disc.

6. The brake assembly of claim 2, wherein the spring further includes a second extending arm that is bent from the first extending arm and extends rearward toward the body.

7. The brake assembly of claim 6, wherein the spring further includes a third extending arm that is bent from the second extending arm and extends forward away from the body.

8. The brake assembly of claim 7, wherein the third extending arm includes a portion obliquely extending inward toward the disc.

9. The brake assembly of claim 7, wherein the spring further includes a tip that is bent from a front end of the third extending arm and extends outward away from the disc.

10. The brake assembly of claim 1, wherein the spring further includes a rear extending arm that extends rearward from the body and is turned in direction to extend forward.

11. The brake assembly of claim 1, wherein the spring has at least one slit penetrating the spring along its extension direction.

12. The brake assembly of claim 1, wherein the bracket includes a locking ledge protruding upward from a portion that contacts a rear side of the brake pad liner,
and the brake pad liner further includes a grip connected to an upper side of the body to be caught by the locking ledge for fixation.

13. A brake pad liner comprising:
a body including
a base,
a lower leg configured to protrude forward from a lower end of the base, and
an upper leg configured to protrude forward from an upper end of the base; and
a spring including
a first extending arm configured to extend forward from one side of the upper leg and
a second extending arm that is bent from the first extending arm and extends rearward toward the body.

14. The brake pad liner of claim 13, wherein the first extending arm is connected to an upper portion of one side of the upper leg.

15. The brake pad liner of claim 13, wherein the first extending arm includes a portion obliquely extending to one side.

16. The brake pad liner of claim 13, wherein the spring further includes a third extending arm that is bent from the second extending arm and extends forward away from the body.

17. The brake pad liner of claim 16, wherein the first extending arm includes a portion obliquely extending to one side, and the third extending arm includes a portion obliquely extending to the other side.

18. The brake pad liner of claim 17, wherein the spring further includes a tip that is bent from a front end of the third extending arm and extends to one side.

19. The brake pad liner of claim 13, wherein the spring has at least one slit penetrating the spring along its extension direction.

20. The brake pad liner of claim 13, further comprising:
a grip configured to extend upward from a front end of the upper leg to extend rearward.
